(19) United States
(12) Patent Application Publication
(10) Pub. No.: US 2009/0150568 A1
(43) Pub. Date: Jun. 11, 2009

(54) METHOD AND APPARATUS FOR SYNCHRONIZING BETWEEN A CENTRALIZED SYSTEM AND A DECENTRALIZED SYSTEM

(76) Inventors: JOHN B. VICENTE, Roseville, CA (US); Kai X. Miao, Boonton, NJ (US); Sanjay Rungta, Phoenix, AZ (US); Jeffrey C. Sedayao, San Jose, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/951,871

(22) Filed: Dec. 6, 2007

(51) Int. Cl. G06F 15/16

(52) U.S. Cl. 709/248

(57) ABSTRACT

Machine-readable media, methods, apparatus and system for synchronizing between a decentralized computing system and a centralized computing system. In some embodiments, a decentralized record may be received from a computing platform, wherein the decentralized record may be created when the computing platform communicates in a decentralized pattern. Information may be detected from the decentralized record to provide detected information, wherein the detected information may reveal a decentralization characteristic of the decentralized record. Then, the decentralized record may be converted into a centralized record while hiding the detected information from the centralized record and the centralized record may be sent to a server.

### BACKGROUND

A centralized system is where multiple terminals are attached to a central computer that controls a majority of resources. Examples for the centralized system may include a client/server system. A decentralized system is the opposite of the centralized system, which is the allocation of resources, both hardware and software, to each individual workstation. Examples of the decentralized system may include a peer-to-peer system and a wireless mesh networking system.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a hybrid system including a centralized system and a decentralized system.

FIG. 2 shows another embodiment of the hybrid system.

FIG. 3 shows an embodiment of a computing platform comprising a proxy for synchronizing decentralized records between the centralized system and the decentralized system.

FIG. 4 shows an embodiment of a method of synchronizing decentralized records between the centralized system and the decentralized system.

### DETAILED DESCRIPTION

The following description describes techniques for synchronizing between a centralized system and a decentralized system. In the following description, numerous specific details such as logic implementations, pseudo-code, methods to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

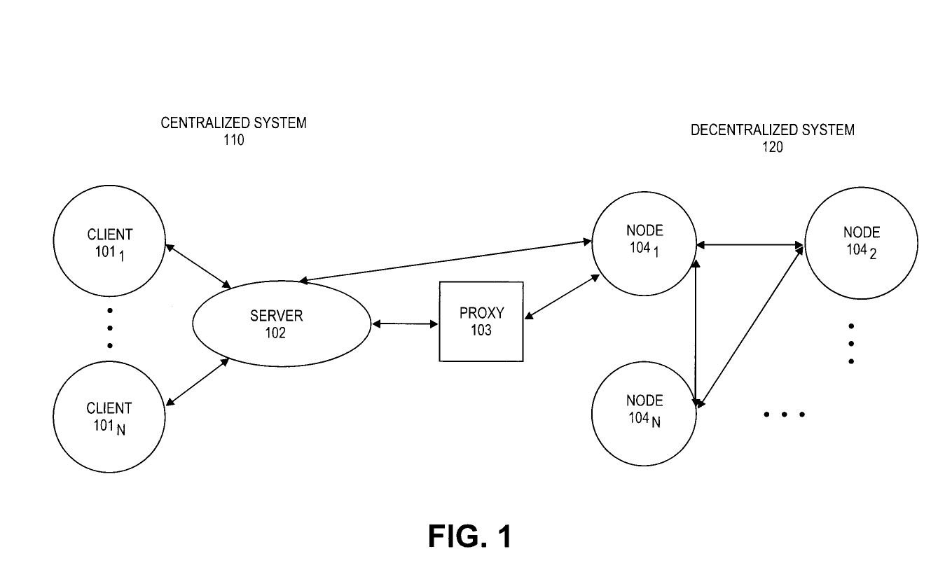

An embodiment of a hybrid system including a centralized system 110 and a decentralized computing system 120 is shown in FIG. 1. As shown, centralized system 110 may comprise multiple clients 101₁-101ₙ and a server 102, in which each client may communicate with the server in a centralized pattern. Decentralized system 120 may comprise multiple nodes 104₁-104ₙ, in which each node are equal and may communicate with one or more other nodes on the system in a decentralized pattern. Examples of decentralized system 120 may include a peer-to-peer system and a wireless mesh networking system.

In addition, a node (e.g., node 104₁) in decentralized system 120 may further communicate with server 102. In an embodiment, the node may communicate either with one or more other nodes in the decentralized pattern or with server 102 in the centralized pattern. In another embodiment, the node may communicate with the one or more other nodes in the decentralized pattern and with server 102 in the centralized pattern simultaneously. Similar technologies may be applied to a client in centralized system 110.

Proxy 103 may help to synchronize a decentralized record, such as e-mail transactions records or file operation records, between centralized system 110 and decentralized system 120 if a node such as node 104₁ in decentralized system 120 needs to synchronize with server 102. In particular, Proxy 103 may detect connection status of the node in decentralized system 120. If it is detected that node 104₁ needs to connect with server 102 to synchronize, proxy 103 may capture the decentralized record created when the node communicates in the decentralized pattern, convert the decentralized record into a centralized record and send the centralized record to server 102.

When converting the decentralized record, proxy 103 may further hide information that may reveal a decentralization characteristic of the decentralized record from the centralized record, so that server 102 may not detect that the node once communicated or is communicating in the decentralized pattern.

With the synchronization of the decentralized records between centralized system 110 and decentralized system 120, the two computing systems may work together in a seamless fashion, which may help creating next generation enterprise solutions that make communication and collaboration more flexible, efficient and lower in cost for enterprise users.

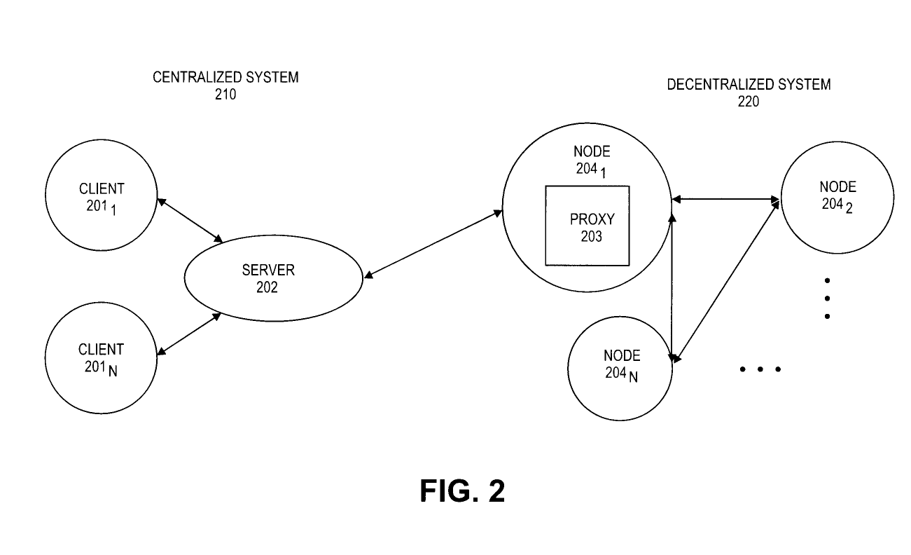

In an embodiment, proxy 103 may be hosted in a device independently of centralized system 110 and decentralized system 120, for example, in a gateway. In another embodiment, proxy 103 may be hosted in one or more nodes of decentralized computing system 120 that may further communicate with server 103, which is illustrated in FIG. 2.

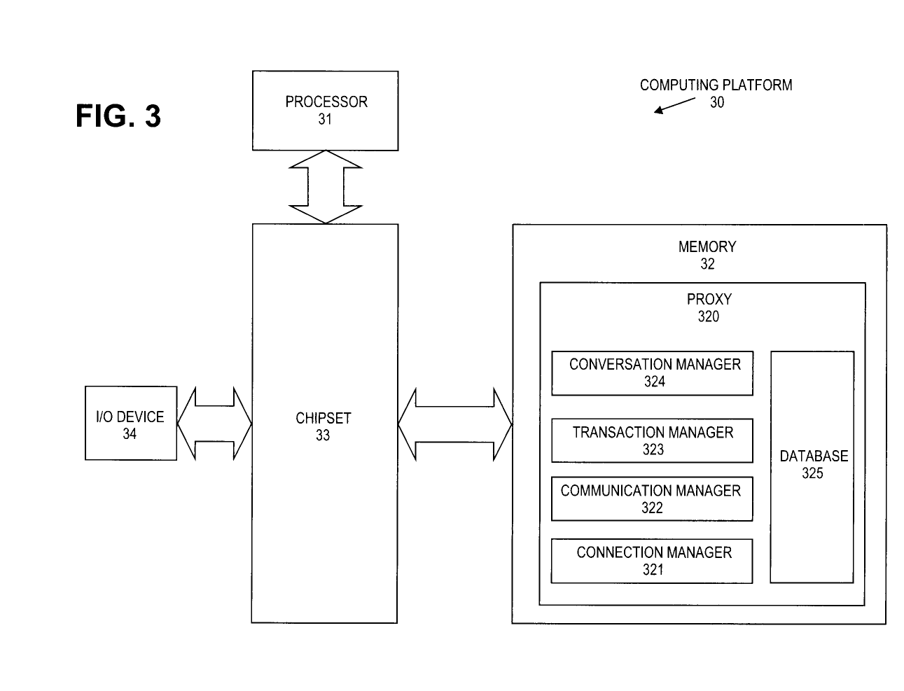

FIG. 3 illustrates an embodiment of a computing platform 30. As illustrated, computing platform 30 may comprise one or more processors 31, memory 32, chipset 33, I/O devices 34, and possibly other components. The one or more processors 31 may be communicatively coupled to various components (e.g., the chipset 33) via one or more buses such as a processor bus. Processors 31 may be implemented as an integrated circuit (IC) with one or more processing cores that may execute codes under a suitable architecture, for example, including Intel® Xeon™, Intel® Pentium™, Intel® Itanium™ architectures, available from Intel Corporation of Santa Clara, Calif.

Memory 32 may store instructions and data in the form of a proxy 320. Embodiments of proxy 320 may be illustrated in FIG. 1 and FIG. 2. Examples of memory 22 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

In an embodiment, proxy 320 may comprise connection manager 321, communication manager 322, transaction manager 323, conversion manager 324 and database 325. Connection manager 321 may detect a connection status of a node (e.g., node 104₁) in decentralized system 120 and determine if the node connects with server 102 to synchronize. If the node connects with server 102, communication manager 322 may manage communications between proxy 320 and the node and communications between proxy 320 and server 102 in a specific protocol for the purpose of synchronizing decentralized records between decentralized system 120 and centralized system 110.

The specific protocol may solve the conflicts incurred by differences between the two systems, such as networking differences. For example, if multiple nodes communicate with each other in the decentralized pattern and one or more of them connect with server 102 independently, proxy 320 may need to communicate with the nodes for the purposes of synchronizing the decentralized records created during the decentralized communication with server 102. In such case, the specific protocol may need to solve the problem caused by the differences between the multi-party decentralized communication and the client/server centralized communication.

Transaction manager 323 may manage the transactions between proxy 320 and the node so as to capture the decentralized records created when the node communicates in the decentralized pattern. Examples of the decentralized records may comprise e-mails and file transactions. Transaction manager 323 may further determine information related to the decentralized records that reveals their decentralization characteristics. The detected information may need to be hided when converting the decentralized records to centralized records in order to disguise the fact that the node once communicated or is communicating in the decentralization pattern. Examples of the detected information may comprise receiving time, sending time, receiver, and sender of the decentralized records.

Conversion manager 324 may convert the decentralized records in a decentralization format to the centralized records in a centralization format while hiding the above detected information from the centralized records. In an embodiment, the conversion manager 324 may comprise a message converter (not shown) and a data converter (not shown) to respectively convert messages and data of the decentralized records.

Database 325 may store the decentralized records, the detected information and the converted centralized records before sending them to server 102.

The chipset 33 may provide one or more communicative paths among one or more processors 31, memory 32 and I/O devices 34. I/O device 34 may receive the decentralized records from the node and send the detected information and centralized records to server 102. Examples of I/O devices 34 may comprise a network card, a bluetooth device, an antenna, and other devices for transceiving data.

Although not illustrated in FIG. 3, it should be appreciated that many technologies may be applied to realize the functionalities of proxy 320. In an embodiment, proxy 320 may be realized by running applications to proxy between centralized system 110 and decentralized system 120 on a virtual machine.

An embodiment of a method of synchronizing a decentralized record between centralized system 110 and decentralized system 120. In block 401, proxy 320 may detect a connection status of a node in decentralized system 120. In block 402, proxy 320 may determine if the node communicates in a decentralized pattern or a centralized pattern based upon its connection status. For example, if the node connects with server 102, proxy 320 may determine it communicates in the centralized pattern. However, if the node connects with another node, proxy 320 may determine it communicates in the decentralized pattern.

If the node communicates in the decentralized communication pattern, then proxy 320 may monitor the decentralization communication in block 403 and capture a decentralized record created during the decentralization communication in block 404. In block 405, proxy 320 may store the decentralized record in a database.

If the node communicates in the centralized communication pattern, then proxy 320 may communicate with the node and server 102 in a specific protocol for the purpose of synchronizing the decentralized record between the two computing systems, in block 406. Then, proxy 320 may retrieve the decentralized record from the database in block 407 and detect information from the decentralized record that reveals decentralization characteristics of the record in block 408. In block 409, proxy 320 may convert the decentralized record into a centralized record while hiding the detected information from the centralize record. In block 410, proxy 320 may send the centralized record and the detected information to server 102.

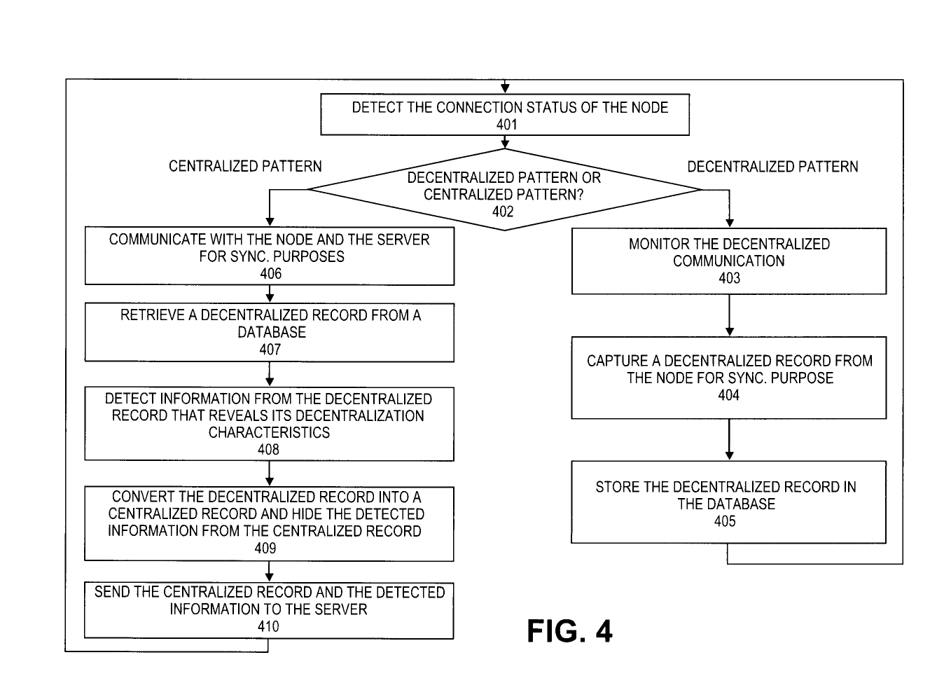

Although FIG. 4 illustrates the embodiment that the node communicates either in the decentralized pattern or in the centralize pattern, it should be appreciated the node may communicates in both of the patterns. In that case, proxy 320 may perform the functionalities of blocks 403-405 as well as the functionalities of blocks 406-410 if it is determined that the node connects to other node(s) in decentralized system 120 as well as to server 102 in centralized system 110.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method, comprising:
receiving a decentralized record from a computing platform, wherein the decentralized record is created when the computing platform communicates in a decentralized pattern;
detecting information from the decentralized record to provide detected information, wherein the detected information reveals a decentralization characteristic of the decentralized record;
converting the decentralized record into a centralized record while hiding the detected information from the centralized record; and
sending the centralized record to a server.

2. The method of claim 1, further comprising sending the detected information to the server.

3. The method of claim 1, wherein the detected information comprises one or more of sending time, receiving time, sender, and receiver for the decentralized record.

4. The method of claim 1, further comprising detecting a connection status of the computing platform, wherein the connection status indicates one or both of whether the computing platform connects to the server in a centralized pattern and whether the computing platform connects to another computing platform in a decentralized pattern.

5. The method of claim 4, wherein the detecting information further comprises detecting the information from the decentralized record for the computing platform if the connection status indicates that the computing platform connects to the server in the centralized pattern.

6. A machine-readable medium comprising a plurality of instructions that in response to being executed result in a system:
receiving a decentralized record from a computing platform, wherein the decentralized record is created when the computing platform communicates in a decentralized pattern;
detecting information from the decentralized record to provide detected information, wherein the detected information reveals a decentralization characteristic of the decentralized record;
converting the decentralized record into a centralized record while hiding the detected information from the centralized record; and
sending the centralized record to a server.

7. The machine-readable medium of claim 6, wherein the plurality of instructions further result in the system, sending the detected information to the server.

8. The machine-readable medium of claim 6, wherein the detected information comprises one or more of sending time, receiving time, sender, and receiver for the decentralized record.

9. The machine-readable medium of claim 7, wherein the plurality of instructions further result in the system, detecting a connection status of the computing platform, wherein the connection status indicates one or both of whether the computing platform connects to the server in a centralized pattern and whether the computing platform connects to another computing platform in a decentralized pattern.

10. The machine-readable medium of claim 9, wherein the instructions that result in the system detecting information further result in the system, detecting the information from the decentralized record for the computing platform if the connection status indicates that the computing platform connects to the server in the centralized pattern.
